(19) United States
(12) Patent Application Publication
(10) Pub. No.: US 2008/0119375 A1
(43) Pub. Date: May 22, 2008

(54) Particulate Silver Biocides and Methods for Biocide use in Fracturing Fluids

(76) Inventors: Evgeny Borisovich Barmatov, Sipachi (RU); Anatoly Vladimirovich Medvedev, Moscow (RU); Marina Vyacheslavovna Barmatova, Sipachi (RU)

Correspondence Address: SCHLUMBERGER TECHNOLOGY CORPORATION;David Cate, IP DEPT., WELL STIMULATION, 110 SCHLUMBERGER DRIVE, MD1, SUGAR LAND, TX, 77478, US

(21) Appl. No.: 11/942,839

(22) Filed: Nov. 20, 2007

(30) Foreign Application Priority Data
Nov. 22, 2006 (RU) 200614116

(51) Int. Cl. A01N 59/16

(52) U.S. Cl. 507/270; 977/810

(57) ABSTRACT

The invention deals with the microorganism protection of liquid media, mainly, in the petroleum industry; and it can be applied for the microorganism protection of liquid media used, particularly, when simulating hydrocarbon production, most preferentially, for liquid medium, used in hydraulic fracturing. Biocide is fine particles consisting of silver, at least partially, their specific surface area being up to 2000 m²/g.

This application claims foreign priority benefits to Russian Patent Application No. 2006141166, filed on Nov. 22, 2006.

### BACKGROUND OF THE INVENTION

The statements in this section merely provide background information related to the present disclosure and may not constitute prior art.

This invention relates to fluids used in treating a subterranean formation. In particular, the invention relates to the use of biocides in such fluids, particularly in fluids for simulating hydrocarbon production, especially in fluids for hydraulic fracturing.

Various types of fluids are used in operations related to the development and completion of wells that penetrate subterranean formations, and to the production of gaseous and liquid hydrocarbons from natural reservoirs into such wells. These operations include perforating subterranean formations, fracturing subterranean formations, modifying the permeability of subterranean formations, or controlling the production of sand or water from subterranean formations. The fluids employed in these oilfield operations are known as drilling fluids, completion fluids, work-over fluids, packer fluids, fracturing fluids, stimulation fluids, conformance or permeability control fluids, consolidation fluids, and the like. Stimulation operations are generally performed in portions of the wells which have been lined with casings, and typically the purpose of such stimulation is to increase production rates or capacity of hydrocarbons from the formation.

The hydraulic fracturing implies cracking in oil-bearing rock due to proppant-contained fracturing liquid injection under high pressure. Natural polymer solutions such as guar gum, cellulose derivatives and so on are mainly used for the hydraulic fracturing liquid. One of the severe problems with hydraulic fracturing is the microorganism-induced degradation of the hydraulic fracturing liquid. The degradation of the hydraulic fracturing liquid is accompanied by great decrease in viscosity, which results in failure to use it, as well as in idle time of equipment. Another important problem in the petroleum industry is the bacterium-induced equipment corrosion. The biocides will be used to prevent the bacterium-induced degradation of the hydraulic fracturing liquid and the equipment corrosion.

Any substance that kills germs and bacteria may be said to be a biocide. The disadvantage of the majority of the biocides currently used in the petroleum industry is a high toxicity level and degradation of the hydraulic fracturing liquid by the biocide. This high toxicity level limits usage in countries having stringent requirements for environmental products used in petroleum production and processing.

A technique is known to obtain a bactericide by reaction of 1,3,5-trimethylhexahydro-1,3,5-triazine and chloride-bearing epichlorohydrin condensate. The disadvantage of this bactericide is its high toxicity level, which adversely affects working environment when producing and using.

It is known to obtain a corrosion inhibitor, namely, a bactericide by mixing an aniline-containing compound, chlorohydric acid, formaldehyde, and water. However, this bactericide has the disadvantage of being labor-intensive when producing and exhibiting low biocidal activity.

A technique is known to obtain a corrosion inhibitor, namely, a bactericide by reaction of 5-16-numbered fatty acid and 10-16-numbered amino-paraffin dissolved in aliphatic alcohol or aromatic solvent, or their mixture. The disadvantage of this bactericide is slight water solubility, which makes use hard.

Based on the chloride methylhexamethylene tetramine a LPE-11 bactericide has been developed. The disadvantage of this technology is low 45-55%-solution processibility index, relatively low lubricating properties, and thermal resistance.

To protect chemical agents used in oil and gas well drilling against microbiological destruction and mud stabilization in time, an epichlorohydrin-hexamethylene tetramine (urotropin) condensate is effective.

However, the chemical agent concentrations to inhibit microorganism growth are extremely expensive, i.e., costing 2-10 times higher than other additives required in the claimed bactericide-and-lubricating agent.

The condensation product is known of distillation residue of the synthetic fatty acids with monoethanol amine and oxyethylated alkyl phenols, i.e. IKB-4 agent, to treat borehole process fluid. The disadvantage of this solution is the requirement of high chemical agent concentration, namely, up to 1% of mud fluid treated.

U.S. Pat. No. 7,032,664 and U.S. Pat. No. 7,036,592 disclosed hydraulic fracturing nanoparticle-containing liquids and patent U.S. Pat. No. 7,033,975B2 describing the use of surface-modified nanoparticles in liquids to recover hydrocarbons from subsurface formations.

Development of a high performance biocide remains an engineering problem and need in the industry, which is solved at least in part by means of the proposed invention. The effect of the developed microparticulate biocide is higher performance along with a decrease in toxicity levels.

### SUMMARY OF THE INVENTION

The current invention provides fluids used in treating a subterranean formation, and in particular, the invention provides hydraulic fracturing fluids. The invention is an improvement over the existing art by providing a less toxic, highly effective biocide such that the fluid is protected from degradation by microorganisms while in the subterranean formation.

In one embodiment of the invention, the invention provides a fracturing fluid useful in subterranean formations comprising at least one biocide wherein said biocide comprises silver microparticles.

In another embodiment, the invention provides a fracturing fluid comprising a silver biocide wherein the biocide concentration is from about 0.001 g to about 1 kg/m³ of the fluid.

In yet another embodiment, the invention comprises a method of treatment of a subterranean formation penetrated by a well bore, including providing a treatment fluid, providing a biocide comprising a silver containing microparticle, mixing the microparticle or a solution thereof into the fluid and pumping the fluid into the wellbore.

In another embodiment, a particulate biocide is provided which is useful in fluids for treatment of subterranean formations, wherein the biocide comprises silver microparticles having a specific surface area of up to about 2000 m²/g.

In another embodiment, the particulate biocide comprises microparticles comprising silver, and further comprising at least one additional element selected from platinum group elements, transition metals, and mixtures thereof.

In another embodiment, the microparticles present in the biocide are nanoparticles. The particle size may vary from about 0.5 nm to about 1000 nm.

In another embodiment, the biocide microparticle also comprises an inert filler.

In another embodiment, the microparticle f at least one inert filler is present in the microparticle at a concentration of from about 0.01% to about 99.99%.

### DETAILED DESCRIPTION OF THE EMBODIMENTS

At the outset, it should be noted that in the development of any such actual embodiment, numerous implementation-specific decisions must be made to achieve the developer's specific goals, such as compliance with system related and business related constraints, which will vary from one implementation to another. Moreover, it will be appreciated that such a development effort might be complex and time consuming but would nevertheless be a routine undertaking for those of ordinary skill in the art having the benefit of this disclosure. The description and examples are presented solely for the purpose of illustrating the preferred embodiments of the invention and should not be construed as a limitation to the scope and applicability of the invention. While the compositions of the present invention are described herein as comprising certain materials, it should be understood that the composition could optionally comprise two or more chemically different materials. In addition, the composition can also comprise some components other than the ones already cited. In the summary of the invention and this detailed description, each numerical value should be read once as modified by the term “about” (unless already expressly so modified), and then read again as not so modified unless otherwise indicated in context. Also, in the summary of the invention and this detailed description, it should be understood that a concentration range listed or described as being useful, suitable, or the like, is intended that any and every concentration within the range, including the end points, is to be considered as having been stated. For example, “a range of from 1 to 10” is to be read as indicating each and every possible number along the continuum between about 1 and about 10. Thus, even if specific data points within the range, or even no data points within the range, are explicitly identified or refer to only a few specific, it is to be understood that inventors appreciate and understand that any and all data points within the range are to be considered to have been specified, and that inventors possession of the entire range and all points within the range.

The microparticles useful in particulate biocides of the invention contain silver, however, they may also be two component or multi-component microparticles. When such multi-component microparticles are used, the biocide may comprise silver microparticles further comprising elements such as platinum group elements, transition metals, and mixtures thereof.

For platinum group element-containing or transition metal-containing microparticles, the silver content of the microparticles is no less than about 0.001% by weight. In preferred microparticles comprise more than 0.1% by weight of is preferable, and more than 1% by weight is more preferable.

The biocide microparticles may have a variety of shapes, i.e., they can be sphere-shaped, rodlike, nanofiber, taper, triangular, polyhedral, sponge, arch-vesicular, net, net-vesicular, r or open celled structures, and combinations of such shapes.

The microparticle-based biocide should be obtained by metal ion reduction from salts using reducing agents. Useful reducing agents include, but are not limited to, the following compounds: alcohols, natrium boron hydride, glucose, polyvinylpyrrolidone, glycols, hydrazine, hydrogen, and others.

Components that govern microparticle shape, size, and stability are polymers, surface-active agents, inorganic salts, and their combinations. For these purposes, aqueous guar gum solutions, cellulose derivatives, amylopectin, and their combinations are usually used.

The biocide is generally provided a powdered substance including microparticles and inert filler. The microparticle content of inert filler varies from about 0.01% by weight to about 99.99% by weight.

Useful inert fillers include, but are not limited to, porous silicates, pumice stone, silica gel, aluminium oxide, coals, and mixtures thereof.

The biocide can also be provided as aqueous-, organic- or aqueous/organic microparticlate solutions. When provided as a solution, the microparticle content of the solution varies from about 0.001% to about 40%.

Biocides of the invention are stable and can be used in fluid media having pH values of from about 4 to about 12.

This invention proposes to use a new silver-containing microparticle (preferentially, nanoparticles) biocide. Antibacterial silver properties are known, however, the use of silver as biocide in the oil and gas field has always been technologically impracticable and unprofitable. Recent achievements in microparticle technology now enable the use of the microparticle-type silver as a microbiocide, both technologically and economically feasible. The microparticles are characterized by a large specific surface area, which allows for increased silver use efficiency.

The properties of the bactericide and its compounds have been known. Silver is a natural biocide capable of killing more than 650 types of bacteria. The silver has an effect on unicellular bacteria by the reaction of silver ions and cell bacteria membranes, which interlocks oxygen transfer to the interior of the bacterium cell, choking a microorganism and killing it. Antimicrobial silver characteristics have found a wide application in medical science and in water treatment devices. The biocide proposed has no toxicity for higher organisms.

The scientific data and patent analysis showed that the petroleum industry has not used silver microparticles as biocide. The biocide developed can be used for long-term storage of liquid and dry components applied in the petroleum industry and, particularly, for hydraulic fracturing liquids, mud solutions and fluids to limit water inflow when flooding or thermal-steam treating.

The biocide concentrations of liquids and dry components vary from approximately 0.001% to approximately 30%.

Hydraulic fracturing fluids of the invention may also comprise gelling polymers for increased viscosity. Some examples of gelling polymers useful in hydraulic fluids of the invention include polymers that are either three dimensional or linear, or any combination thereof. Polymers include natural polymers, derivatives of natural polymers, synthetic polymers, biopolymers, and the like, or any mixtures thereof. Some nonlimiting examples of suitable polymers include guar gums, high-molecular weight polysaccharides composed of mannose and galactose sugars, or guar derivatives such as hydropropyl guar (HPG), carboxymethyl guar (CMG), and carboxymethylhydroxypropyl guar (CMHPG). Cellulose derivatives such as hydroxyethylcellulose (HEC) or hydroxypropylcellulose (HPC) and carboxymethylhydroxyethylcellulose (CMHEC) may also be used in either crosslinked form, or without crosslinker in linear form. Xanthan, diutan, and scleroglucan, three biopolymers, have been shown to be useful as well. Synthetic polymers such as, but not limited to, polyacrylamide, polyvinyl alcohol, polyethylene glycol, polypropylene glycol, and polyacrylate polymers, and the like, as well as copolymers thereof, are also useful. Also, associative polymers for which viscosity properties are enhanced by suitable surfactants and hydrophobically modified polymers can be used, such as cases where a charged polymer in the presence of a surfactant having a charge that is opposite to that of the charged polymer, the surfactant being capable of forming an ion-pair association with the polymer resulting in a hydrophobically modified polymer having a plurality of hydrophobic groups,.

In some cases, the polymer, or polymers, include a linear, nonionic, hydroxyalkyl galactomannan polymer or a substituted hydroxyalkyl galactomannan polymer. Examples of useful hydroxyalkyl galactomannan polymers include, but are not limited to, hydroxy-C₁-C₄-alkyl galactomannans, such as hydroxy-C₁-C₄-alkyl guars. Preferred examples of such hydroxyalkyl guars include hydroxyethyl guar (HE guar), hydroxypropyl guar (HP guar), and hydroxybutyl guar (HB guar), and mixed C₂-C₄, C₂/C₃, C₃/C₄, or C₂/C₄ hydroxyalkyl guars. Hydroxymethyl groups can also be present in any of these.

As used herein, substituted hydroxyalkyl galactomannan polymers are obtainable as substituted derivatives of the hydroxy-C₁-C₄-alkyl galactomannans, which include: 1) hydrophobically-modified hydroxyalkyl galactomannans, e.g., C₁-C₂₄-alkyl-substituted hydroxyalkyl galactomannans, e.g., wherein the amount of alkyl substituent groups is preferably about 2% by weight or less of the hydroxyalkyl galactomannan; and 2) poly(oxyalkylene)-grafted galactomannans (see, e.g., A. Bahamdan & W. H. Daly, in Proc. 8PthP Polymers for Adv. Technol. Int'l Symp. (Budapest, Hungary, September 2005) (PEG- and/or PPG-grafting is illustrated, although applied therein to carboxymethyl guar, rather than directly to a galactomannan)). Poly(oxyalkylene)-grafts thereof can comprise two or more than two oxyalkylene residues; and the oxyalkylene residues can be C₁-C₄ oxyalkylenes. Mixed-substitution polymers comprising alkyl substituent groups and poly(oxyalkylene) substituent groups on the hydroxyalkyl galactomannan are also useful herein. In various embodiments of substituted hydroxyalkyl galactomannans, the ratio of alkyl and/or poly(oxyalkylene) substituent groups to mannosyl backbone residues can be about 1:25 or less, i.e. with at least one substituent per hydroxyalkyl galactomannan molecule; the ratio can be: at least or about 1:2000, 1:500, 1:100, or 1:50; or up to or about 1:50, 1:40, 1:35, or 1:30. Combinations of galactomannan polymers according to the present disclosure can also be used.

As used herein, galactomannans comprise a polymannose backbone attached to galactose branches that are present at an average ratio of from 1:1 to 1:5 galactose branches:mannose residues. Preferred galactomannans comprise a 1→4-linked β-D-mannopyranose backbone that is 16-linked to α-D-galactopyranose branches. Galactose branches can comprise from 1 to about 5 galactosyl residues; in various embodiments, the average branch length can be from 1 to 2, or from 1 to about 1.5 residues. Preferred branches are monogalactosyl branches. In various embodiments, the ratio of galactose branches to backbone mannose residues can be, approximately, from 1:1 to 1:3, from 1:1.5 to 1:2.5, or from 1:1.5 to 1:2, on average. In various embodiments, the galactomannan can have a linear polymannose backbone. The galactomannan can be natural or synthetic. Natural galactomannans useful herein include plant and microbial (e.g., fungal) galactomannans, among which plant galactomannans are preferred. In various embodiments, legume seed galactomannans can be used, examples of which include, but are not limited to: tara gum (e.g., from Cesalpinia spinosa seeds) and guar gum (e.g., from Cyamopsis tetragonoloba seeds). In addition, although embodiments of the present invention may be described or exemplified with reference to guar, such as by reference to hydroxy-C₁-C₄-alkyl guars, such descriptions apply equally to other galactomannans, as well.

The fluid of the invention may include viscoelastic surfactants. The viscoelastic surfactant system may contain a zwitterionic surfactant, for example a surfactant or mixture of surfactants having the formula:

RCONH—(CH₂)ₐ(CH₂CH₂O)ₘ(CH₂)_{b}—N⁺(CH₃)₂—(CH₂)_{a′}(CH₂CH₂O)_{m′}(CH₂)_{b′}COO⁻

in which R is an alkyl group that contains from about 17 to about 23 carbon atoms which may be branched or straight chained and which may be saturated or unsaturated; a, b, a′, and b′ are each from 0 to 10 and m and m′ are each from 0 to 13, a and b are each 1 or 2 if m is not 0 and (a+b) is from 2 to 10 if m is 0; a′ and b′ are each 1 or 2 when m′ is not 0 and (a′+b′) is from 1 to 5 if m′ is 0; (m+m′) is from 0 to 14; and CH₂CH₂O may also be OCH₂CH₂. The zwitterionic surfactant may have the betaine structure:

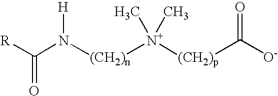

in which R is a hydrocarbon group that may be branched or straight chained, aromatic, aliphatic or olefinic and has from about 14 to about 26 carbon atoms and may contain an amine; n=about 2 to about 4; and p=1 to about 5, and mixtures of these compounds. The betaine may be oleylamidopropyl betaine or erucylamidopropyl betaine and may contain a co-surfactant.

The viscoelastic surfactant system may contain a cationic surfactant, for example a surfactant or mixture of surfactants having the structure:

R₁N⁺(R₂)(R₃)(R₄)X⁻

in which R₁ has from about 14 to about 26 carbon atoms and may be branched or straight chained, aromatic, saturated or unsaturated, and may comprise a carbonyl, an amide, a retroamide, an imide, a urea, or an amine; R₂, R₃, and R₄ are each independently hydrogen or a C₁ to about C₆ aliphatic group which may be the same or different, branched or straight chained, saturated or unsaturated and one or more than one of which may be substituted with a group that renders the R₂, R₃, and R₄ group more hydrophilic; the R₂, R₃ and R₄ groups may be incorporated into a heterocyclic 5- or 6-member ring structure which includes the nitrogen atom; the R₂, R₃ and R₄ groups may be the same or different; R₁, R₂, R₃ and/or R₄ may contain one or more ethylene oxide and/or propylene oxide units; and X⁻ is an anion; and mixtures of these compounds. As a further example, R₁ contains from about 18 to about 22 carbon atoms and may contain a carbonyl, an amide, or an amine; R₂, R₃, and R₄ contain from 1 to about 3 carbon atoms, and X⁻ is a halide. As a further example, R₁ comprises from about 18 to about 22 carbon atoms and may comprise a carbonyl, an amide, or an amine, and R₂, R₃, and R₄ are the same as one another and comprise from 1 to about 3 carbon atoms. The cationic viscoelastic surfactant system optionally contains amines, alcohols, glycols, organic salts, chelating agents, solvents, mutual solvents, organic acids, organic acid salts, inorganic salts, oligomers, polymers, co-polymers, and mixtures of said materials, present at a concentration of between about 0.01 and about 10 percent, for example at a concentration of between about 0.01 and about 1 percent. The amphoteric surfactant may be, for example, an amine oxide, for example an amidoamine oxide.

When incorporated, the polymers or surfactants may be present at any suitable concentration. In various embodiments hereof, the total concentration of the gelling polymer(s) in the fluid may be an amount of from about 0.1 pound to less than about 60 pounds per thousand gallons of fluid, or from about 1.5 to less than about 40 pounds per thousand gallons, from about 1.5 to about 35 pounds per thousand gallons, 1.5 to about 25 pounds per thousand gallons, or even from about 2 to about 10 pounds per thousand gallons.

Fluid compositions useful in some embodiments of the invention may also include a gas component, produced from any suitable gas that forms an energized fluid or foam when introduced into an aqueous medium. See, for example, U.S. Pat. No. 3,937,283 (Blauer et al.) hereinafter incorporated by reference. Preferably, the gas component comprises a gas selected from the group consisting of nitrogen, air, argon, carbon dioxide, and any mixtures thereof. More preferably the gas component comprises nitrogen or carbon dioxide, in any quality readily available. The gas component may assist in the fracturing and acidizing operation, as well as the well clean-up process. The fluid may contain from about 10% to about 90% volume gas component based upon total fluid volume percent, preferably from about 20% to about 80% volume gas component based upon total fluid volume percent, and more preferably from about 30% to about 70% volume gas component based upon total fluid volume percent.

Breakers may optionally be used in some embodiments of the invention. The purpose of this component is to “break” or diminish the viscosity of the fluid so that this fluid is even more easily recovered from the formation after the need for zone isolation is past. Breakers such as oxidizers, enzymes, or acids may be used. Breakers reduce the polymer's molecular weight by the action of an acid, an oxidizer, an enzyme, or some combination of these on the polymer itself. In the case of borate-crosslinked gels, increasing the pH and therefore increasing the effective concentration of the active crosslinker (the borate anion), will allow the polymer to be crosslinked. Lowering the pH can just as easily eliminate the borate/polymer bonds. At pH values at or above 8, the borate ion exists and is available to crosslink and cause gelling. At lower pH, the borate is tied up by hydrogen and is not available for crosslinking, thus gelation caused by borate ion is reversible. Preferred breakers include 0.1 to 20 pounds per thousands gallons of conventional oxidizers such as ammonium persulfates, live or encapsulated, or potassium periodate, calcium peroxide, chlorites, and the like. In oil producing formations the film may be at least partially broken when contacted with formation fluids (oil), which may help de-stabilize the film.

The fluids may also include fillers. Useful fillers include fibers. Fibers used may be hydrophilic or hydrophobic in nature, but hydrophilic fibers are preferred. Fibers can be any fibrous material, such as, but not necessarily limited to, natural organic fibers, comminuted plant materials, synthetic polymer fibers (by non-limiting example polyester, polyaramide, polyamide, novoloid or a novoloid-type polymer), fibrillated synthetic organic fibers, ceramic fibers, inorganic fibers, metal fibers, metal filaments, carbon fibers, glass fibers, ceramic fibers, natural polymer fibers, and any mixtures thereof Particularly useful fibers are polyester fibers coated to be highly hydrophilic, such as, but not limited to, DACRON® polyethylene terephthalate (PET) Fibers available from Invista Corp. Wichita, Kans., USA, 67220. Other examples of useful fibers include, but are not limited to, polylactic acid polyester fibers, polyglycolic acid polyester fibers, polyvinyl alcohol fibers, and the like. When used in fluids of the invention, the fiber component may be included at concentrations from about 1 to about 15 grams per liter of the liquid phase of the fluid, preferably the concentration of fibers are from about 2 to about 12 grams per liter of liquid, and more preferably from about 2 to about 10 grams per liter of liquid.

Embodiments of the invention may also include particles that are substantially insoluble in the fluids, and which may be useful in the zone after isolation has been removed, e.g., when the zone is a fracture in the formation. Particulate material carried by the treatment fluid and held in the gel may remain in a gel-isolated fracture after the gel has been broken and cleaned up, thus propping open the fracture when the fracturing pressure is released and the well is put into production. Suitable particulate materials include, but are not limited to, sand, walnut shells, sintered bauxite, glass beads, ceramic materials, naturally occurring materials, or similar materials. Mixtures of proppants can be used as well. If sand is used, it will typically be from about 20 to about 100 U.S. Standard Mesh in size. Naturally occurring materials may be underived and/or unprocessed naturally occurring materials, as well as materials based on naturally occurring materials that have been processed and/or derived. Suitable examples of naturally occurring particulate materials for use as proppants include, but are not necessarily limited to: ground or crushed shells of nuts such as walnut, coconut, pecan, almond, ivory nut, brazil nut, etc.; ground or crushed seed shells (including fruit pits) of seeds of fruits such as plum, olive, peach, cherry, apricot, etc.; ground or crushed seed shells of other plants such as maize (e.g., corn cobs or corn kernels), etc.; processed wood materials such as those derived from woods such as oak, hickory, walnut, poplar, mahogany, etc. including such woods that have been processed by grinding, chipping, or other form of particalization, processing, etc. Further information on nuts and composition thereof may be found in Encyclopedia of Chemical Technology, Edited by Raymond E. Kirk and Donald F. Othmer, Third Edition, John Wiley & Sons, Volume 16, pages 248-273 (entitled “Nuts”), Copyright 1981, which is incorporated herein by reference.

Embodiments of the invention may use other additives and chemicals that are known to be commonly used in oilfield applications by those skilled in the art. These include, but are not necessarily limited to, materials in addition to those mentioned hereinabove, such as breaker aids, oxygen scavengers, alcohols, scale inhibitors, corrosion inhibitors, fluid-loss additives, bactericides, iron control agents, organic solvents, and the like. Also, they may include a co-surfactant to optimize viscosity or to minimize the formation of stabilized emulsions that contain components of crude oil, or as described hereinabove, a polysaccharide or chemically modified polysaccharide, natural polymers and derivatives of natural polymers, such as cellulose, derivatized cellulose, guar gum, derivatized guar gum, or biopolymers such as xanthan, diutan, and scleroglucan, synthetic polymers such as polyacrylamides and polyacrylamide copolymers, oxidizers such as persulfates, peroxides, bromates, chlorates, chlorites, periodates, and the like. Some examples of organic solvents include ethylene glycol monobutyl ether, isopropyl alcohol, methanol, glycerol, ethylene glycol, mineral oil, mineral oil without substantial aromatic content, and the like.

The procedural techniques for pumping fluids down a wellbore to fracture a subterranean formation are well known. The person that designs such treatments is the person of ordinary skill to whom this disclosure is directed. That person has available many useful tools to help design and implement the treatments, including computer programs for simulation of treatments.

The following examples are presented to illustrate the preparation and properties of energized aqueous fluids comprising heteropolysaccharides and a surfactant, and should not be construed to limit the scope of the invention, unless otherwise expressly indicated in the appended claims. All percentages, concentrations, ratios, parts, etc. are by weight unless otherwise noted or apparent from the context of their use.

### EXAMPLES

The biocide performance efficiency was investigated using the hydraulic fracturing liquid. The hydraulic fracturing guar gum-base liquid was prepared of 5 g/l gum content. Three specimens were investigated.

Specimen 1. The hydraulic fracturing biocide-free liquid to be used as a reference specimen.

Specimen 2. The hydraulic fracturing liquid containing commercially available isothiazolin-base bactericide. The biocide content was 0,0042 g/l.

Specimen 3. The hydraulic fracturing liquid containing the ionic agent-stabilized silver microparticle-base aqueous biocide solution. The silver microparticle content was 0,032 g/l.

The specimens were stored at a 25° C. temperature for 12 days. To log characteristics of the hydraulic fracturing liquid its viscosity was used obtained with Chandler viscosimeter 3500 according to a standard procedure at the room temperature. The Table below gives characteristics of the hydraulic fracturing liquid.

TABLE 1
Specimen viscosity in CP at 170 c⁻¹.

| | Start of | | | | |
|---|---|---|---|---|---|
| Specimen | experiment | 3 days | 6 days | 9 days | 12 days |
| 1 | 60 | 9 | 0 | 0 | 0 |
| 2 | 60 | 56 | 57 | 54 | 52 |
| 3 | 60 | 57 | 57 | 53 | 51 |

It can be clearly seen from the results in Table 1 that specimens 2 and 3 containing silver nanoparticles and an isothaiazolin-based biocide kept high viscosity for a long period, showing that the gel was maintained, while gel composition was observed by the third day for specimen 1, which contained no biocide.

What is claimed is:

1. A biocide useful for treatment fluid in the petroleum industry comprising silver microparticles, said particles having a specific surface area of up to 2000 m²/g.

2. The biocide of claim 1 wherein the microparticles are nanoparticles.

3. The biocide of claim 1 wherein the microparticles have an average size of from about 0.5 nm to about 1000 nm.

4. The biocide of claim 1 wherein the particles are selected from two-component or multi-component microparticles containing silver and further containing at least one element selected from the group consisting of platinum group elements, transition metals, and mixtures thereof, said silver content being no less than 0.001% by weight.

5. The biocide of claim 1 wherein said microparticle further comprises at least one inert filler, said at least one filler being present in the microparticle at a concentration of from about 0.01% to about 99.99%.

6. The biocide of claim 5 wherein said inert filler is selected from the group consisting of porous silicates, pumice stone, silica gel, aluminum oxide, coals, and mixtures thereof.

7. A treatment fluid for use in a subterranean formation penetrated by a wellbore, the fluid comprising a biocide comprising silver microparticles wherein said biocide being present in said fluid at a concentration of from about 0.001 g to about 1 kg/m³ of the fluid.

8. The treatment fluid of claim 7 wherein said treatment is hydraulic fracturing.

9. The treatment fluid of claim 7 wherein the microparticles have an average size of from about 0.5 nm to about 1000 nm.

10. The treatment fluid of claim 7 wherein the particles are selected from two-component or multi-component microparticles containing silver and further containing at least one element selected from the group consisting of platinum group elements, transition metals, and mixtures thereof, said silver content being no less than 0.001% by weight.

11. The treatment fluid of claim 7 wherein the microparticle further comprises at least one inert filler, said at least one filler being present in the microparticle at a concentration of from about 0.01% to about 99.99%.

12. The treatment fluid of claim 11 wherein said inert filler is selected from the group consisting of porous silicates, pumice stone, silica gel, aluminum oxide, coals, and mixtures thereof.

13. The treatment fluid of claim 7 wherein the fluid further comprises an oligomers or polymers is selected from the group consisting of guar, guar derivative, cellulose, cellulose derivative, gum or diutan.

14. The treatment fluid of claim 7 wherein the fluid further comprises a viscoelastic surfactant.

15. A treatment method for a subterranean formation penetrated by a well bore, including the steps of:
a) providing a treatment fluid,
b) providing a biocide comprising silver containing microparticles,
c) mixing the silver containing microparticles or a solution comprising the silver containing microparticles into the fluid, and
d) pumping the fluid into the wellbore.

16. The treatment method of claim 15 wherein said biocide is mixed with the fluid at a concentration of from about 0.001 g to approximately 1 kg/m³ of the fluid.

17. The treatment method of claim 16 wherein the microparticles have an average size of from about 0.5 nm to about 1000 nm.

18. The treatment method of claim 16 wherein the particles are selected from two-component or multi-component microparticles containing silver and further containing at least one element selected from the group consisting of platinum group elements, transition metals, and mixtures thereof, said silver content being no less than 0.001% by weight.

19. The treatment method of claim 16wherein the microparticle further comprises at least one inert filler, said at least one filler being present in the microparticle at a concentration of from about 0.01% to about 99.99%.

20. The treatment method of claim 20 wherein said inert filler is selected from the group consisting of porous silicates, pumice stone, silica gel, aluminum oxide, coals, and mixtures thereof.
